(19) United States
(12) Patent Application Publication
(10) Pub. No.: US 2007/0007845 A1
(43) Pub. Date: Jan. 11, 2007

(54) Built-up commutator and micro-motor employing the same

(75) Inventors: Yoshimi Suzuki, Tokyo (JP); Kesao Noguchi, Ebina-shi (JP)

Correspondence Address: BRUCE L. ADAMS, ESQ., SUITE 1231, 17 BATTERY PLACE, NEW YORK, NY, 10004, US

(73) Assignee: SUZUKI CONTACTPOINT INDUSTRY CO., LTD.

(21) Appl. No.: 11/481,590

(22) Filed: Jul. 6, 2006

(30) Foreign Application Priority Data
Jul. 7, 2005 (JP) 2005-199261

(51) Int. Cl. H01R 39/04

(52) U.S. Cl. 310/236; 310/233

(57) ABSTRACT

This invention provides a built-up commutator which can effectively contribute to light weight and small size thereof due to decreasing the number of constitutional components and enhancing an assembling accuracy, and provides a micro-motor employing the built-up commutator. According to FIG. 1, a built-up commutator includes at least a supporting pedestal 13 and a plurality of commutator pieces each of which is disposed respectively, the supporting pedestal fixed in flange-shape to a rotating shaft, each of the commutator pieces including a foot piece formed as to abut on the supporting pedestal side and a uprising piece bent from the foot piece side and formed as to abut the rotating shaft side, each of the commutator pieces is positioned and fixed to the shaft 12 side and the pedestal 13 side with air gaps intervening between the commutator pieces and an insulating layer intervening on contact surfaces with the shaft 12 and with the pedestal 13. A micro-motor of the invention is formed as to housing the built-up commutator 11.

### FIELD OF THE INVENTION

The present invention relates to a built-up commutator which has high accuracy in assembling and which can contribute to small-sizing, light weight, low cost and long operating life, and a micro-motor employing the built-up commutator.

### BACKGROUND OF THE INVENTION

Recently micro-motors are used as vibration sources for generating vibration to devices such as cellular phones, toothbrushes, alarm clocks or the like. These devices are eagerly required to be more small-sized and thereby the motors are requested to be more micro-sized.

The request that the motor becomes to be more micro-sized requires a commutator, which is a constitutional component of the motor, to be more micro-sized. Developments that enhance an assembling accuracy and decrease the commutator-weight have been active.

For example, Japanese Patent Application Publication No. 2001-17918 discloses a cylindrical vibrating micro-motor of which the number of processing steps could be decreased by decreasing the number of components.

FIG. 7 is an expanded longitudinal sectional view showing the structure of a built-up commutator which have been generally adopted up to now, as well as in Japanese Patent Application Publication No. 2001-17918. According to FIG. 7, a commutator 1 includes a metallic supporting pedestal 3, a base 4 formed with synthetic resin, a plurality of commutator pieces 5 and a fixing ring 6 positioning and fixing the commutator pieces 5, the pedestal 3 fixed in flange-shape on the rotating shaft 2, the base 4 supported on the pedestal 3, the commutator pieces 5 fixed and arranged on the base 4 through an adhesive agent. The fixing ring 6 positions and fixes the commutator pieces 5.

The base 4 includes a base body 4a having a larger diameter and a cylinder body 4b integrated with the base body 4a with the rotating shaft 2 freely penetrating the base 4, the base body 4a supported on the supporting pedestal 3 which is positioned in the concave portion formed in the bottom side of the base body around the shaft, the cylinder body 4b projecting in the axial direction of the rotating shaft 2.

Each of the commutator pieces 5 includes a foot piece 5a and a uprising piece 5b, the foot piece 5a having a narrow width and arranged along the surface of the base body 4a of the base 4, the uprising piece 5b having a wide width and bent toward the axial direction of the rotating shaft 2 from the side of the foot piece 5a.

Each of the commutator pieces 5 is arranged in the space between the neighbor piece around the rotating shaft 2, respectively, and is positioned and fixed through the fixing ring 6 in physical relationship of concentric arrangement with the cylinder body 4b and as well as the rotating shaft 2.

However, since each of the commutator pieces 5 of the commutator 1 shown in FIG. 7 is disposed through the base 4 supported on the supporting pedestal 3 and is positioned and fixed by using the fixing ring 6, four kinds of constitutional components are required and thereby it disadvantageously increases assembling steps, manufacturing costs and weight thereof.

Further, since each of the commutator piece 5 is disposed through the base 4 formed with synthetic resin having poorer processing accuracy than metal, an assembling accuracy is also disadvantageously decreased.

### SUMMARY OF THE INVENTION

It is an object of the present invention to provide a built-up commutator which can enhance an assembling accuracy by decreasing the number of the constitutional components in order to solve the advantages included in a commutator of related arts described above and a micro-motor employing the built-up commutator.

The first aspect of this invention (a built-up commutator) includes at least a supporting pedestal and a plurality of commutator pieces each of which is disposed respectively, the supporting pedestal fixed in flange-shape to a rotating shaft, each of the commutator pieces including a foot piece formed as to abut on the supporting pedestal side, and a uprising piece bent from the foot piece side and formed as to abut on the rotating shaft side. It is mainly characterized in that each of the commutator pieces is positioned and fixed to the supporting pedestal side and to the rotating shaft side with air gaps intervening between the commutator pieces and an insulating layer intervening on the contact surfaces with the supporting pedestal and with the rotating shaft.

Each of the commutator pieces can be positioned and fixed to the supporting pedestal side and to the rotating shaft side in the state that an insulating layer is integratedly formed previously on the contact surfaces with the supporting pedestal and with the rotating shaft and in the state that an adhesive agent intervenes between the insulating layer and each of the commutator pieces. Each of the commutator pieces can be also positioned and fixed to the supporting pedestal side and to the rotating shaft side with an insulating adhesive agent intervening on the contact surfaces with the supporting pedestal and with the rotating shaft.

Each of the commutator pieces can be positioned and fixed through a fixing ring inserted in the physical relationship of concentric arrangement with each of the commutator pieces and the rotating shaft. In this case the fixing ring can include guide portions on the contact surfaces with the commutator pieces in order to freely position the foot piece and/or the uprising piece. The supporting pedestal can have a cavity which is open in the lower face thereof and further also can have cutout portions in the peripheral wall formed with the cavity.

The second aspect of the invention (micro-motor) is mainly characterized that the motor houses the commutator described above.

As the effect of this invention, according to the first aspect of the invention (built-up commutator), since the built-up commutator which enhances an assembling accuracy in the state that the number of the constitutional components is decreased can be formed, light weight, small size and low manufacturing cost of the commutator can be achieved. Since a base 4 shown in FIG. 7 which has been necessary up to now is no more needed, the commutator of the invention can be small-sized by a factor of a cylinder body 4b of the base 4.

According to the second aspect of the invention (micro-motor), since the motor employs the built-up commutator having an enhanced assembling accuracy in the state that the number of the constitutional components is decreased, the micro-motor can have a high performance. Further small size of the whole shape, light weight of the total mass and long operating life of brushes or the like can be achieved and as well as a smaller sized motor also can be achieved.

### BRIEF DESCRIPTION OF THE DRAWINGS

FIG. 1 is an expanded longitudinal sectional view which shows an example applying the first aspect of the present invention to a commutator for a three-poles motor.

FIG. 2 is a plane view corresponding to FIG. 1.

FIG. 3 is a perspective view which shows the whole shape of the commutator corresponding to FIG. 1 adding brushes 51.

FIG. 4 is an explanation view which shows the other example of the first aspect of the invention (built-up commtator) partly exploded.

FIG. 5 (a) is an expanded perspective view showing the structure of a supporting pedestal which is one of a constitutional components in the first aspect of the invention (built-up commtator).

FIG. 5 (b) is an expanded perspective view showing another structure of the supporting pedestal which is one of the constitutional components in the first aspect of the invention (built-up commtator).

FIG. 5 (c) is an expanded perspective view showing still another structure of the supporting pedestal which is one of the constitutional components in the first aspect of the invention (built-up commtator).

FIG. 6 is an expanded explanation and cutaway view which shows an example applying the second aspect of the invention (micro-motor) hosing the first aspect of the invention to a cylindrical vibrating micro-motor.

FIG. 7 is an expanded longitudinal sectional view which shows an example of the structure of a built-up commutator generally employed up to now.

### DETAILED DESCRIPTION OF THE PREFERRED EMBODIMENTS

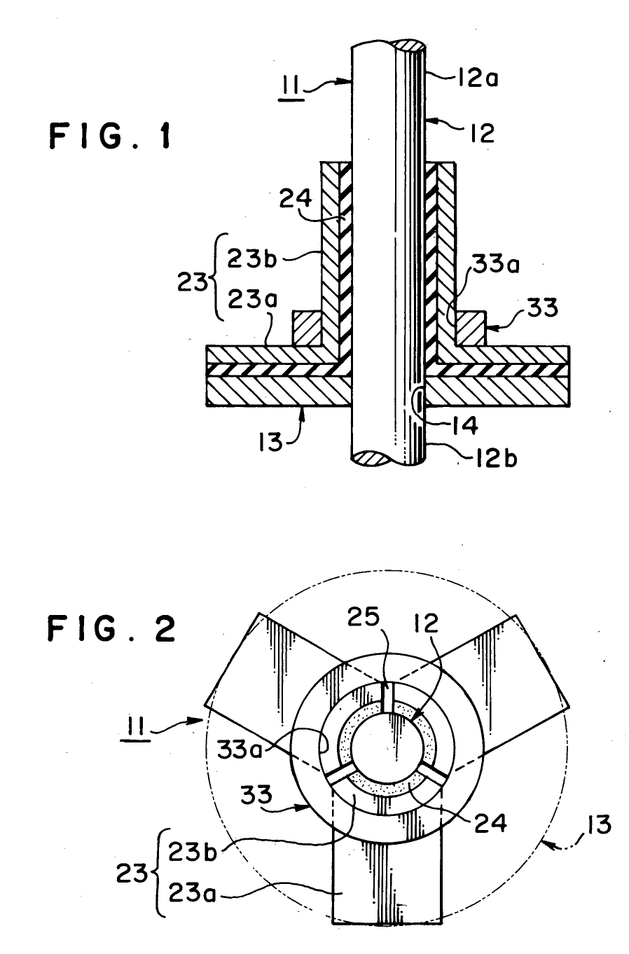

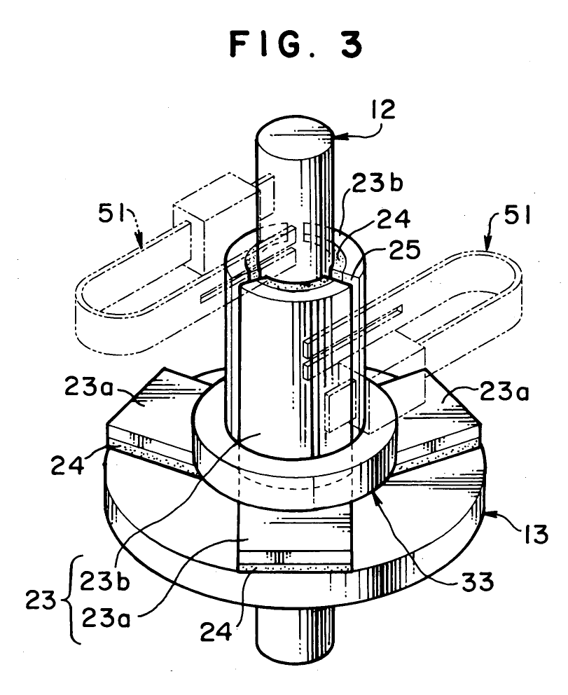

FIG. 1 is an expanded longitudinal sectional view which shows an example applying the first aspect of the present invention to a commutator for a three-poles motor. FIG. 2 is a plane view corresponding to FIG. 1. FIG. 3 is a perspective view which shows the whole shape of the commutator corresponding to FIG. 1 as the relation with brushes 51.

According to FIGS. 1 to 3, the whole of the commutator 11 of the invention includes a supporting pedestal 13 fixed in the flange-shape on a rotating shaft 12, a plurality of commutator pieces 23 disposed throutgh the supporting pedestal 13 and a fixing ring 33 for fixing the position of the plurality of commutator pieces 23.

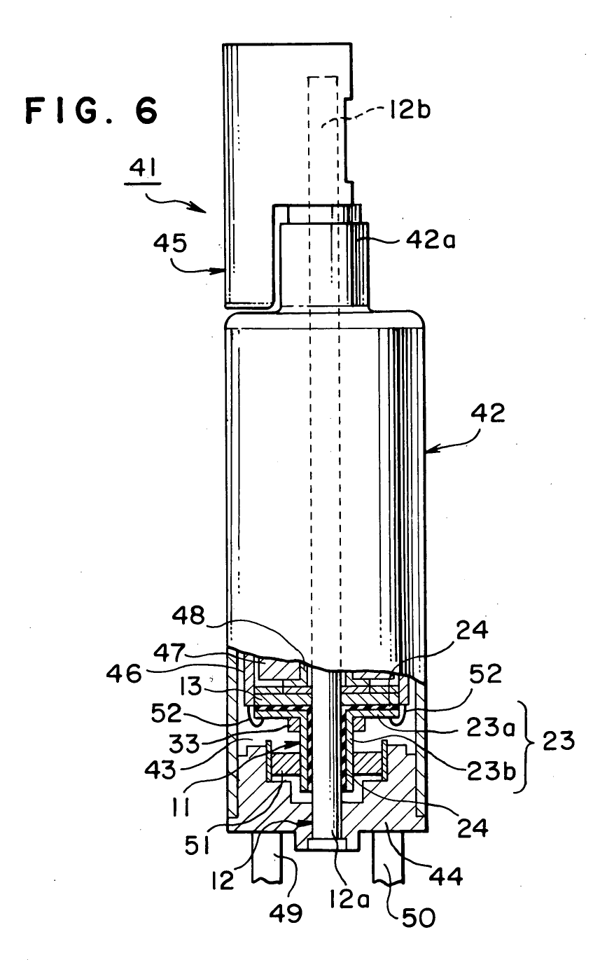

The supporting pedestal 13 has an adequate outer diameter and a thickness which are determined by the relationship with the internal diameter of a casing 42 of the micro-motor 41 shown in FIG. 6. For example, the outer diameter and the thickness of the pedestal 13 are approximately 2.5 mm to 3.0 mm, and 0.3 mm, respectively. The pedestal 13 is formed with a circular metal made form stainless steel or copper alloy.

In this case the supporting pedestal 13 is integratedly fixed on the rotating shaft 12 with the pedestal 13 pressed into the rotating shaft 12 to the adequate position of the shaft 12 of which the outer diameter is approximately, for example, 0.6 mm through a through-hole 14 formed in the center of the pedestal.

Each of the three commutator pieces 23 is respectively positioned and separately fixed to the supporting pedestal 13 which is fixed on the rotating shaft 12.

That is, the each of the commutator pieces 23 formed with an adequate conductor material of which a thickness is, for example, 0.05 mm to 0.15 mm is formed with each of the commutator pieces 23 including a foot piece 23a and a uprising piece 23b. The foot piece 23a is arranged as to abut to the surface of the supporting pedestal 13 and the uprising piece 23b is formed in the state that the back end (the rotating shaft side) of the foot piece 23a is bent upright.

In this case the width of the uprising piece 23b of the each of the commutator piece 23 is changed according to the number of motor poles. The width of the uprising piece shown in FIGS. 1 to 3 is relatively wider due to the relation with the outer circumferential length of the rotating shaft 12, since the commutator 11 has three commutator pieces for the three-poles motor. The foot piece 23a of each of the commutator pieces 23 has a constant width with no relation of the number of the motor poles. For example, the foot piece 23a is relatively narrow in case of three-poles motor, however it is preferable that the foot piece 23a has a constant width or a broaden width at the end of the foot piece in view of convenience of an electrode wiring or maintaining assembly-stabilization.

Since the uprising piece 23b of each of the commutator piece 23 is needed to be arranged as to abut to the curved surface of the rotating shaft 12, the uprising piece 23b is formed in the circular arc of which the length is determined according to the number of the motor poles.

Further, an insulating layer 24 is formed previously on the contact surface between the foot piece 23a and the supporting pedestal 13, and on the contact surface between the uprising piece 23b and the rotating shaft 12. For example, a thickness of the insulating layer 24 shown in FIG. 3 is approximately 3 μm to 30 μm. In this case the insulating layer can be formed by painting an insulating paint or by applying an insulating sheet to an adhesive agent.

In order to fix each of the commutator pieces 23 to the rotating shaft side and the supporting pedestal 13 side, a fixing ring 33 formed with adequate synthetic resin is inserted to the rotating shaft 12 and each of the commutator pieces 23 in the state that each of the commutator pieces intervening an air gap 25 of 10 μm to 150 μm between the commutator pieces and in the state that the rotating shaft and the commutator pieces are formed in concentric arrangement. The air gap 25 of 10 μm to 150 μm between the commutator pieces can maintain electric non-conductive state.

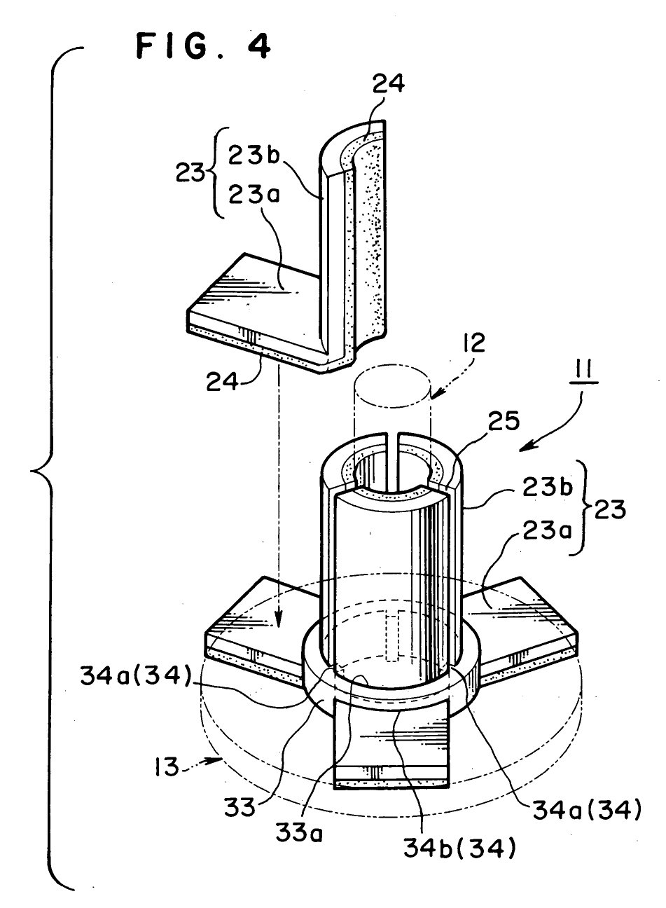

FIG. 4 is an explanation view which shows a concrete shape of the commutator which is formed by using the fixing ring 33 in order to dispose the commutator pieces 23 without displacement. In FIG. 4 the fixing ring 33 includes guide portions 34 in order to freely position the foot piece 23a and the uprising pieces 23b on the contact surface with each of the commutator pieces 23.

That is, the fixing ring 33 shown in FIG. 4 includes the guide portions 34 having three of a positing projection 34a and three of a guided groove 34b in case of a three poles motor. Each or the positioning projections 34a protrudes toward the center of the shaft from an inner circumferential surface of the fixing ring 33 by 120 degrees. Each of the guided grooves 34b is formed on the bottom face of the fixing ring 33 between the positioning projections 34a. In this example, as requested, the guide portions 34 can be formed only with the projections 34a or only with the guided grooves 34b.

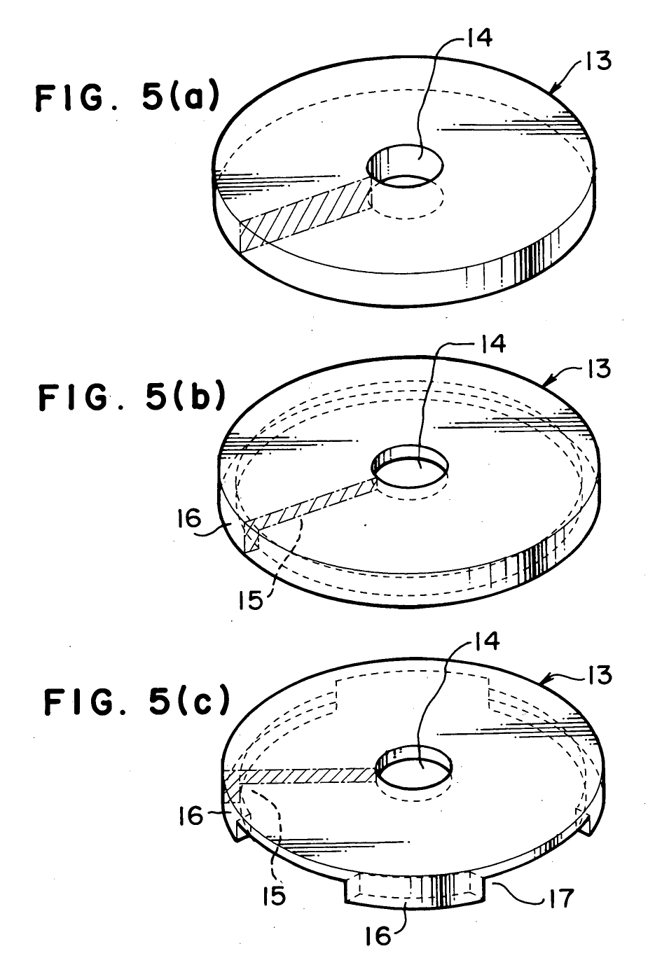

FIGS. 5 (a) to 5 (c) are explanation views which show a concrete shape of the supporting pedestal 13. FIGS. 5 (a) and 5 (b) show the pedestal formed with a simple plane plate and the pedestal including a cavity which has an opening processed by drawing, respectively. FIG. 5 (c) shows the pedestal having cutout portions 17 which are processed by bending at a predetermined interval on the outer circumferential wall of the pedestal shown in FIG. 5 (b). The pedestal in FIGS. 5 (b) or 5 (c) will be adopted in view of lighter weight of the supporting pedestal 13.

On the other hand, FIG. 6 is an expanded explanation and cutaway view in which the a main component is cut away showing an example applying the second aspect of the invention (micro-motor) hosing the first aspect of the invention (built-up commutator) described above to a cylindrical vibrating micro-motor.

According to FIG. 6, the micro-motor 41 includes a casing 42, a brush holder 44 and the commutator 11. The casing 42 is pipe-shaped with one end of the casing having a narrow diameter and the casing has a function as a yoak, the casing having a diameter of approximate 4 mm and a wall thickness of approximate 0.2 mm. The brush holder 44 is pressed into an opening portion 43 disposed in the other end of the casing 42. The commutator 11 includes each of the commutator pieces fixed to the rotating shaft 12 of which one end 12a is supported in the brush holder 44.

Further the micro-motor includes a eccentric weight 45 for generating vibration by the weight 45 mounted in an eccentric way on the other end 12b of the rotating shaft 12 protruding from an apex 42a of the casing 42 with the center of the weight mass going around the shaft. In FIG. 6 the reference numerals of 46, 47 and 48 show a cylindrical coreless armature, a field magnet and a magnet support, respectively. The reference numerals of 49 and 50 show lead wires and 52 shows a connecting wire between the commutator 11 and the armature 46.

Next, operation/working-effect of the first aspect of this invention (built-up commutator) will be described according to an example shown in FIGS. 1 to 3. Each of the commutator pieces 23 has the insulating layer 24. Each of the commutator pieces 23 is positioned and fixed by using the fixing ring 33 in the state that each of the commutator pieces is directly supported on the pedestal 13 made from metal fixed on the shaft 12, Therefore, the commutator can be formed with three numbers of elements except the rotating shaft 12.

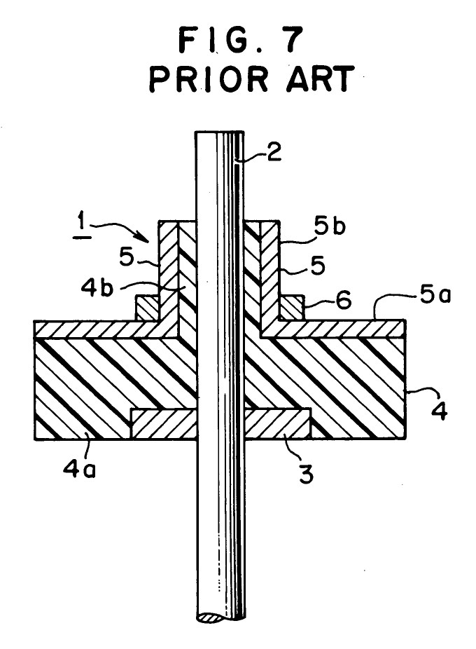

That is, since the commutator 11 can be formed without using a base 4 shown in FIG. 7 as constituent components, it can reduce the number of the components. A lighter weight, a small size and a cost down in manufacturing of the commutator can be achieved by reducing the number of process in manufacturing. Therefore, since the light weight of the total mass and unnecessity of a base 4 shown in FIG. 7 can be achieved, the commutator 11 can be down-sized by a factor of a cylinder body 4b of the base 4. Since the diameter and the circumferential length of a sliding portion of the commutator 11 can be small, long life of the motor itself due to decreasing wear of the brushes can be achieved.

The supporting pedestal 13 supporting the foot pieces 23a of each of the commutator pieces 23 is formed with metallic material which is different from the base 4 shown in FIG. 7 and which has high accuracy of machining, thereby the assembling accuracy can be increased.

Since the foot piece 23a and the uprising piece 23b of each of the commutator pieces 23 are fixed through the insulating layer 24 by using the fixing ring 33 on the supporting pedestal 13 and the rotating shaft 12, respectively, occurrence of an electric failure is definitely prevented.

When, as shown in FIG. 4, the positing projection 34a and/or the guided groove 34b are formed in the fixing ring 33, the foot piece 23b of each of the commutator pieces 23 can be positioned in the guided groove 34b and the uprising piece 23b can be positioned between the positioning projections 34a, 34a. Therefore, a displacement of the commutator pieces in assembly and a stagger of the commutator pieces 23 in rotation of the shaft 12 effectively are prevented. Therefore a longer operating life of the commutator 11 which has been assembled can be achieved.

Further, when the supporting pedestal 13 shown in FIGS. 5 (b) or 5 (c) instead of the pedestal in FIG. 5 (a) is used, the weight of the pedestal can be decreased. Thereby, the lighter weight of the pedestal can effectively contribute to a lighter whole weight of the commutator 11.

Since the micro motor of the second aspect of this invention houses the commutator 11 which obtains operation/working-effect as described above, a lighter weight and a down size of the motor can be achieved and the motor having a high performance and a long operating life can be provided.

This invention is described above according to embodiments as shown in the drawings. The invention may be embodied in other changed forms without departing from the spirit or essential characteristics thereof. For example, the commutator of the first aspect of the invention is shown as the example according to a three-poles motor, however, the commutator can be formed with the adequate number of the commutator pieces according to the number of motor-poles, for example, five-poles motor, seven-poles motor and so on.

Each of the commtator pieces 23 can be also fixed by an insulating adhesive agent intervened between the rotating shaft 12 and the supporting pedestal 13. Further, the each of the commutator 23 can be fixed and arranged only by boding fixation without using the fixing ring 33. Still further, each of the commutator 23 may be fixed by the fixing ring 33 in the state that only the insulating layer 24 intervenes without using an adhesive agent.

On the other hand, regarding the micro motor of the second aspect of the invention, the embodiment applying to the cylindrical vibrating micro-motor is shown in the drawing, however, if a motor houses the commutator of the first aspect, the motor can be selectable as a motor of the first aspect of the invention irrespective of sizes or kinds thereof.

1. A built-up commutator comprising:
a supporting pedestal fixed in a flange-shape to a rotating shaft;
a plurality of commutator pieces, each of the plurality of commutator pieces disposed separately and including a foot piece and a uprising piece, the foot piece formed as to abut to the supporting pedestal side, the uprising piece formed as to be bent from the foot piece side and as to abut to the rotating shaft side; and
wherein the each of the plurality of commutator pieces is positioned and fixed to the supporting pedestal side and to the rotating shaft side with an air gap intervening between the each of the plurality of commutator pieces and an insulating layer intervening between contact surfaces with the supporting pedestal and with the rotating shaft.

2. A built-up commutator according to claim 1, wherein the insulating layer is integratedly formed previously on the contact surfaces with the supporting pedestal and with the rotating shaft, and the each of the plurality of commutator pieces is positioned and fixed in the state that an adhesive agent intervenes between the insulating layer and each of the commutator pieces.

3. A built-up commutator according to claim 1, wherein the insulating layer is formed with an insulating adhesive agent and the each of the plurality of commutator pieces is positioned and fixed on the contact surfaces with the supporting pedestal and with the rotating shaft by the insulating adhesive agent.

4. A built-up commutator according to claim 1, wherein the each of the plurality of commutator pieces is fixed through a fixing ring in the state that the fixing ring is inserted in physical relationship of concentric arrangement with the each of the plurality of commutator pieces and the rotating shaft.

5. A built-up commutator according to claim 1, wherein the supporting pedestal includes a cavity which is open on the lower face thereof.

6. A built-up commutator according to claim 2, wherein the each of the plurality of commutator pieces is fixed through a fixing ring in the state that the fixing ring is inserted in physical relationship of concentric arrangement with the each of the plurality of commutator pieces and the rotating shaft.

7. A built-up commutator according to claim 3, wherein the each of the plurality of commutator pieces is fixed through a fixing ring in the state that the fixing ring is inserted in physical relationship of concentric arrangement with the each of the plurality of commutator pieces and the rotating shaft.

8. A built-up commutator according to claim 4, wherein the fixing ring includes guide portions on the contact faces between the fixing ring and the plurality of commutator pieces in order to freely position the foot piece and/or the uprising piece.

9. A built-up commutator according to claim 5, wherein the supporting pedestal includes cutout portions in the peripheral wall formed with the cavity.

10. A built-up commutator according to claim 6, wherein the fixing ring includes guide portions on the contact faces between the fixing ring and the plurality of commutator pieces in order to freely position the foot piece and/or the uprising piece.

11. A built-up commutator according to claim 7, wherein the fixing ring includes guide portions on the contact faces between the fixing ring and the plurality of commutator pieces in order to freely position the foot piece and/or the uprising piece.

12. A micro-motor housing the built-up commutator according to any one of claim 1 to 11.
